(19) United States
(12) Patent Application Publication
(10) Pub. No.: US 2026/0022698 A1
(43) Pub. Date: Jan. 22, 2026

(54) ELECTROMECHANICAL ACTUATION NETWORK WITH INTEGRATED COOLING RESERVOIR

(71) Applicant: Hamilton Sundstrand Corporation, Charlotte, NC (US)

(72) Inventors: Naison Mastrocola, Goshen, CT (US); Ryan Susca, Windsor, CT (US)

(21) Appl. No.: 18/775,797

(22) Filed: Jul. 17, 2024

(51) Int. Cl. F04B 49/22; F02C 7/14

(52) U.S. Cl. CPC F04B 49/22; F02C 7/14

(57) ABSTRACT

A fluid system includes a fluid inlet fluidically connected to a fluid source, a boost pump fluidically coupled to the fluid inlet, a control valve network fluidically coupled to the boost pump, a cooling reservoir fluidically coupled to the control valve network, wherein the cooling reservoir comprises a bleed orifice, an actuation network fluidically coupled to the check valve network and the cooling reservoir, and a fluid outlet path fluidically coupled to the actuation network. The fluid system may be housed within a gas turbine engine, and can distribute cooling flow from the cooling reservoir to the actuation network when the gas turbine engine is in an off state, mitigating thermal soak back during engine off conditions.

### CROSS-REFERENCE TO RELATED APPLICATION(S)

This application is related to U.S. Application No. ______ filed on Jul. 17, 2024, entitled “ELECTROMECHANICAL ACTUATION NETWORK WITH INTEGRATED COOLING PUMP” with Attorney Docket No. 180279US01-U200-P15613US1.

### BACKGROUND

This disclosure relates to pressure-controlled pump systems and, more particularly, to pressure-controlled pump systems that include thermal management for actuators, such as in a gas turbine engine. In traditional pressure-controlled pump systems, pumps supply fluid to actuators among other potential system components. Fluid supplied to the actuators provides cooling during an operational condition of the system, but the actuators can experience high temperature thermal conditions during a non-operational (e.g., engine off) condition that may impact operability and service life of the actuators. Thus, a configuration that provides cooling to the actuators during a non-operational condition is desirable.

### SUMMARY

A fluid system includes a fluid inlet fluidically connected to a fluid source, a boost pump fluidically coupled to the fluid inlet, a control valve network fluidically coupled to the boost pump, a cooling reservoir fluidically coupled to the control valve network, wherein the cooling reservoir comprises a bleed orifice, an actuation network fluidically coupled to the check valve network and the cooling reservoir, and a fluid outlet path fluidically coupled to the actuation network. The fluid system may be housed within a gas turbine engine, and can distribute cooling flow from the cooling reservoir to the actuation network when the gas turbine engine is in an off state, mitigating thermal soak back during engine off conditions.

A method of operating a fluid circuit provides cooling flow from a cooling reservoir to an actuation network. A boost pump is operated and a control valve network is opened to provide fluid to the actuation network during an operational state. A portion of the fluid provided to the actuation network is bled off to fill the cooling reservoir with pressurized fluid during the operational state. Operation of the boost pump is ceased, and the control valve network is closed, during a non-operational state, thereby depressurizing the cooling reservoir. Cooling flow is distributed from the cooling reservoir to the actuation network during the non-operational state. The cooling flow is then directed from the actuation network to a fluid outlet path.

### BRIEF DESCRIPTION OF THE DRAWINGS

FIG. 1 is a block diagram of a fluid system including an actuation network and a spring-loaded cooling reservoir.

FIG. 2 is a schematic diagram of the fluid system including the actuation network and the spring-loaded cooling reservoir.

FIG. 3 is a flowchart depicting a method for providing cooling flow to the actuation network via the spring-loaded cooling reservoir within the fluid system.

### DETAILED DESCRIPTION

The techniques of this disclosure relate to a cooling fluid reservoir within an eletromechanical actuator (EMA) cooling loop. The system provides for an electromechanical actuation network which allows for higher fuel efficiency than other actuation systems. The actuation network requires cooling as the electronic components within EMAs are typically unable to withstand the temperatures in a fuel pump environment. During operation of the fuel pump, cooling fuel flow keeps the actuator network at an appropriate temperature for operation. Upon engine shutdown, however, thermal soak back can occur, and no cooling fuel flow is available to mitigate the high temperatures. The techniques of this disclosure include a cooling flow reservoir that fills up during engine operation. Upon engine shutdown, the spring-charged reservoir depressurizes and hence distributes fuel flow through the actuator network, thereby allowing for cooling in an engine off condition. The fuel flows through the actuator network and returns back to the fluid tank

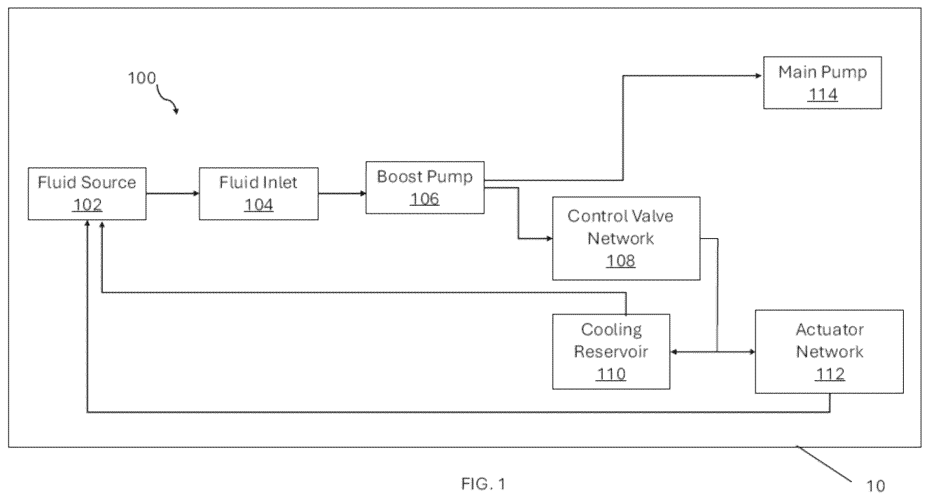

FIG. 1 is a block diagram of an example of fluid system 100. Fluid system 100 is housed within engine 10, wherein engine 10 can be, for example, a gas turbine engine. Fluid system 100 includes fluid source 102, fluid inlet 104, boost pump 106, control valve network 108, cooling reservoir 110, actuator network 112, and main pump 114. Fluid source 102 is a fuel source containing cooling fuel (e.g., a fuel tank). Control valve network 108 can include one or more control valves for controlling cooling fuel flow through fluid system 100. The one or more control valves can be configured to open or close in response to fluid pressure generated by boost pump 106. The one or more control valves can be, for example, electro-hydraulic servo valves (EHSV).

Boost pump 106 can be any suitable pump operable to increase fluid pressure of fluid flowing through fluid inlet 104. Examples of boost pump 106 include non-positive displacement pumps and positive displacement pumps and can be mechanically driven and/or electrically driven. In some examples, boost pump 106 can be a centrifugal pump, or other non-positive displacement pump, that is mechanically-driven. Main pump 114 is used to deliver fuel to a fuel injector in the combustion section of engine 10 through, for example, a distribution system.

Actuator network 112 can include any number of actuators. Each of the actuators within actuator network 112 can be an electromechanical actuator (EMA). Electromechanical actuators can be linear EMAs or rotary EMAs that are coupled to one or more variable geometry components operatively associated with fluid system 100. Actuator network 112 can also include a control unit associated with each EMA. Control units can include a processor, a microprocessor, a controller, a digital signal processor (DSP), an application specific integrated circuit (ASIC), a field-programmable gate array (FPGA), or other equivalent discrete or integrated logic circuitry that governs operation of respective electromechanical actuators. Control units can be associated with a temperature rating above which operation life of the control unit is degraded or non-operative.

In an example configuration, fluid source 102 is fluidly coupled to fluid inlet 104. Fluid inlet 104 is fluidly coupled to boost pump 106 and to control valve network 108. Control valve network 106 is fluidly coupled to boost pump 108, cooling reservoir 110 and actuator network 112. Actuator network 112 is fluidly coupled to cooling reservoir 110 and fluid source 102.

In an example, while engine 10 is operational, fluid system 100 is in an operational state, in which fluid is conducted from fluid source 102 to fluid inlet 104 and through boost pump 106. Boost pump 106 supplies pressurized fluid to main pump 114. Main pump 114 can be connected to a downstream distribution system (not pictured) for providing fuel to a combustor within the gas turbine engine. The control valves of control valve network 108 can be opened and/or closed in response to pressure generated by boost pump 106. Fluid can then flow from control valve network 108 to actuator network 112 in cases where actuation is required. Also, when fluid flows from control valve network 108 to actuator network 112, a portion of the flow is bled off to cooling reservoir 110, which is configured in some embodiments as a pressurizable reservoir that is pressurized and filled during operation of engine 10 by bleeding a portion of the pressurized fluid flow from boost pump 106 that flows through control valve network 108 to actuator network 112. Excess bleed fluid can flow from cooling reservoir 110 back to fluid source 102. Also, after actuation, fluid can also flow from actuator network 112 back to fluid source 102.

In the example described, while engine 10 is operational, fluid flow through actuator network 112 allows for thermal cooling, thereby allowing the actuator(s) within actuator network 112 to withstand the surrounding high temperatures. While engine 10 is in an off state, fluid system 100 is in a non-operational state, in which boost pump 106 is not operational and thermal soak back can occur, thereby subjecting actuator network 112 to high temperatures. Fluid system 100 allows for cooling flow to continue flowing through actuator network 112 in the engine off condition, from cooling reservoir 110. In operation, upon shutdown, when pressure from boost pump 106 is lost, cooling reservoir 110 is operable to source fluid stored therein into actuator network 112. Fluid flow through actuator network 112 during the engine off condition allows for cooling of the actuator(s) within actuator network 112. Also, after actuation, fluid can flow from actuator network 112 to fluid source 102 (e.g., a fluid tank), thus replenishing fluid source 102.

In the example described, fluid system 100 provides several advantages. Fluid system 100 allows for EMAs within actuator network 112 to receive cooling flow in both engine on and engine off conditions. Thermal soak back that can occur in engine off conditions is mitigated by cooling reservoir 110 which stores and selectively provides cooling fluid to the EMAs within actuator network 112. Further, the components required to add cooling reservoir 110 to fluid system 100 are simple and inexpensive. Thus, a very minor and simple addition to fluid system 100 can provide mitigation of the effects of thermal soak back.

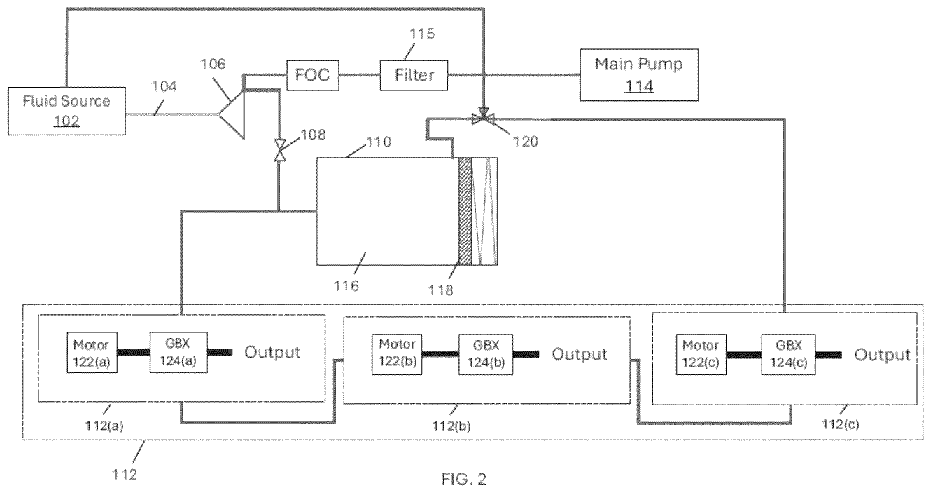

FIG. 2 is a schematic diagram of an example of fluid system 100. Fluid system 100 includes the same components detailed in the block diagram depiction of FIG. 1, including fluid source 102, fluid inlet 104, boost pump 106, control valve network 108, cooling reservoir 110, actuator network 112, and main pump 114. The depiction of FIG. 2 also includes additional details of fluid system 100. Fuel oil cooler FOC and filter 115 are shown in the fluid path between boost pump 106 and main pump 114. Further details of fluid system 100 are described below.

In the illustrated example, control valve network 108 is shown schematically as a spring-loaded check valve, which is spring biased to a closed position, and is caused to be opened by boost pressure from boost pump 106, and will return to a closed position when boost pump 106 stops operating. It is understood that any number of control valves can be used within control valve network 108.

Cooling reservoir 110, in the example shown in FIG. 2, includes pressurizable reservoir 116 and spring-loaded piston 118. Reservoir 116 and piston 118 may be configured so that, as reservoir 116 is filled with pressurized fluid, piston 118 is forced back within the interior of cooling reservoir 110, past a bleed orifice that allows for excess fluid to exit cooling reservoir 110 (and return to fluid source 102, through selector valve 120) when a defined volume of reservoir 116 is filled. In other embodiments, cooling reservoir may include sensors and valves that operate to monitor the amount of fluid in reservoir 116 and provide for egress of excess fluid.

Actuator network 112, an example of which is shown in more detail in FIG. 2, depicts a plurality of actuators including actuator 112(a), actuator 112(b), and actuator 112(c). It is understood that fluid system 100 can include any number of actuators. Actuator 112(a) includes motor 122(a) and gearbox 124(a). Actuator 112(b) includes motor 122(b) and gearbox 124(b). Actuator 112(c) includes motor 122(c) and gearbox 124(c).

In an example configuration, fluid source 102 is fluidly coupled to fluid inlet 104. Fluid inlet 104 is fluidly coupled to boost pump 106 and control valve network 108. Control valve network 108 is fluidly coupled to boost pump 106, cooling reservoir 110, and actuator network 112. Boost pump 106 is fluidly coupled to main pump 114 via a flow path through fuel oil cooler FOC and filter 115, and to actuator network 112 through control valve network 108. Actuator network 112 is fluidly coupled to fluid source 102 via selector valve 120.

In an example, within actuator network 112, actuator 112(a), actuator 112(b), and actuator 112(c) are fluidly connected in a series arrangement such that fluid flows from actuator 112(a) to actuator 112(b), to actuator 112(c), then to fluid source 102 or cooling reservoir 110 via selector valve 120. Within actuator 112(a), motor 122(a) is mechanically coupled to gearbox 124(a). Actuator 112(a) is mechanically coupled to an output which is actuated when actuator 112(a) is functional. Within actuator 112(b), motor 122(b) is mechanically coupled to gearbox 124(b). Within actuator 112(c), motor 122(c) is mechanically coupled to gearbox 124(c).

As described in the description of FIG. 1, fluid system 100 can be contained within an engine. While the engine is operational, fluid is conducted from fluid source 102 to fluid inlet 104. Boost pump 106 pressurizes the fluid for delivery to main pump 114 through fuel oil cooler FOC and filter 115. Fuel oil cooler FOC cools the fluid flow from boost pump 106, and filter 115 filters contaminants within the fluid flow from boost pump 106.

The control valve(s) of control valve network 108 can be opened and/or closed in response to pressure generated by boost pump 106. In the depicted embodiments, the fluid pressure generated by boost pump 106 causes the control valve(s) of control valve network 108 to open. Thus, during operation of the engine, fluid is permitted to flow through the control valve(s) of control valve network 108 to cooling reservoir 110 and actuator network 112. Specifically, when fluid flows from control valve network 108 to actuator network 112, a portion of the flow is bled off to cooling reservoir 110, in which pressurizable reservoir 116 is pressurized and filled during operation of engine 10 by bleeding a portion of the pressurized fluid flow from boost pump 106 that flows through control valve network 108 to actuator network 112. Excess bleed fluid can flow from cooling reservoir 110 back to fluid source 102, for example by forcing piston 118 past a bleed orifice in reservoir 116 so that the excess fluid will exit from cooling reservoir 110. Also, after actuation, fluid can flow from actuator network 112 back to fluid source 102.

As described in the description of FIG. 1, while the engine is operational, fluid system 100 is in an operational state, in which fluid flow through actuator network 112 allows for thermal cooling, thereby allowing actuator 112(a), actuator 112(b), and actuator 112(c) within actuator network 112 to withstand the surrounding high temperatures. While the engine is in an off state, fluid system 100 is in a non-operational state in which boost pump 106 is not operational and thermal soak back can occur, thereby subjecting actuator network 112 to high temperatures.

In an example, fluid system 100 allows for cooling flow to continue flowing through actuator network 112 in the engine off condition, from cooling reservoir 110. In operation, upon shutdown, when pressure from boost pump 106 is lost, control value network 108 will close, and cooling reservoir 110 is then operable to source fluid stored therein into actuator network 112, by piston 118 forcing fluid in pressurizable reservoir 116 (which is now depressurized) to flow toward actuator network 112, due to the spring-loading of piston 118 operating to force fluid out of cooling reservoir 110. Fluid flow through actuator network 112 during the engine off condition allows for cooling of actuators 112(a), 112(b) and 112(c) within actuator network 112. Fluid flows through actuators 112(a), 112(b), and 112(c) in series, allowing for cooling of motor 122(a), motor 122(b), and motor 122(c). Also, after actuation, fluid can flow from actuator network 112 to fluid source 102 (e.g., a fluid tank), thus replenishing fluid source 102.

In the example described, fluid can exit from actuator network 112 and flow to selector valve 120. Based upon the configuration of selector valve 120, fluid can flow through filter 115, fuel oil cooler FOC, and boost pump 106 and thereafter recirculate through fluid system 100 (i.e., through control valve 108 and back into cooling reservoir 110). Additionally or alternatively, fluid can exit from actuator network 112 and flow to selector valve 120 wherein the fluid is directed back to fluid source 102 (e.g., a fluid tank), thus replenishing fluid source 102.

In the example described, fluid system 100 provides the advantages listed above with respect to the description of FIG. 1. Further, the schematic diagram of fluid system 100 depicts the manner in which multiple actuators (i.e., 112(a), 112(b), and 112(c)) receive the benefit of cooling flow from cooling reservoir 110.

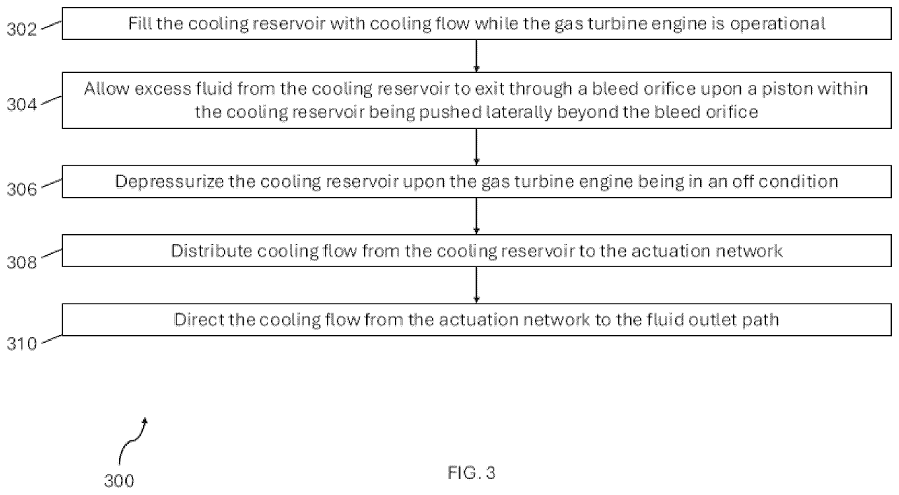

FIG. 3 is a flowchart depicting an example of method 300 for providing cooling flow to actuation network 112 via the cooling reservoir 110 within fluid system 100. Method 300 addresses providing cooling flow during an engine off condition to mitigate thermal soak back. In the description of method 300, reference will be made to the component numbers of FIGS. 1 and 2 for clarity.

Method 300 begins at step 302, wherein fluid is directed from fluid source 102 through fluid inlet 104 to boost pump 106, and on through control valve network 108 to actuation network 112 and cooling reservoir 110. During engine operation when fluid is provided to actuation network 112, a portion of the fluid flow is bled off to cooling reservoir 110, to fill the cooling reservoir with fluid.

At step 304, as fluid fills the capacity of cooling reservoir 110, excess fluid is allowed to exit from cooling reservoir 110 through a bleed orifice, once piston 118 within cooling reservoir 110 is pushed beyond the bleed orifice. This excess fluid may be recirculated back to fluid source 102, for example.

At step 306, upon engine shutdown, boost pressure from boost pump 106 is lost, and control valve network 108 will close, so that fluid flow to actuator network 112 is discontinued, and cooling reservoir 110 is depressurized. Then, at step 308, cooling reservoir 110 is operable to distribute fluid stored therein into actuator network 112. This fluid flow can flow through downstream series connected actuators (e.g., actuator 112(a), actuator 112(b), and actuator 112(c)) to provide cooling and mitigate the effects of thermal soak back.

At step 310, the cooling flow is directed from actuation network 112 to a fluid outlet path (i.e., an exit of actuation network 112). Specifically, the cooling flow is directed to fluid source 102, or recirculated through fluid system 100 based upon operation of selector valve 120.

The techniques of this disclosure allow for an electromechanical actuation network which benefits from cooling during engine operation and during an engine off condition. During operation of the fluid system, cooling flow (e.g., cooling fuel) keeps the actuator network at an appropriate temperature for operation, and some fluid (e.g., fuel) is accumulated in a cooling reservoir. Upon engine shutdown, the cooling reservoir provides cooling flow to the actuator network. The techniques of this disclosure thus allow EMAs to remain cool and operational upon engine shutdown.

### Discussion of Possible Embodiments

The following are non-exclusive descriptions of possible embodiments of the present invention.

A fluid system includes a fluid inlet fluidically connected to a fluid source, a boost pump fluidically coupled to the fluid inlet, a control valve network fluidically coupled to the boost pump, a cooling reservoir fluidically coupled to the control valve network, wherein the cooling reservoir comprises a bleed orifice, an actuation network fluidically coupled to the check valve network and the cooling reservoir, and a fluid outlet path fluidically coupled to the actuation network.

The fluid system of the preceding paragraph can optionally include, additionally and/or alternatively, any one or more of the following features, configurations and/or additional components:

The cooling reservoir may be a pressurizable reservoir.

The fluid system may be housed within a gas turbine engine.

The cooling reservoir may be configured to receive bleed flow from fluid flowing to the actuation network while the gas turbine engine is operational, thereby filling the cooling reservoir with fluid.

The cooling reservoir may be configured to be at a maximum capacity when a spring-loaded piston within the cooling reservoir is pushed beyond the bleed orifice.

The cooling reservoir may be configured such that excess fluid entering the cooling reservoir when the cooling reservoir is at the maximum capacity is directed through the bleed orifice for return to the fluid source.

The cooling reservoir may configured to distribute cooling flow to the actuation network when the gas turbine engine is in an off state.

The cooling reservoir may be configured to distribute cooling flow to the actuation network via operation of a spring-loaded piston within the cooling reservoir.

The fluid outlet path may fluidically coupled to the fluid source.

The fluid system may include a filter fluidically coupled to an outlet of the boost pump.

The fluid system may include a fuel oil cooler fluidically coupled between the filter and the boost pump.

A method of operating a fluid circuit to provide cooling to an actuation network, the fluid circuit including a fluid inlet fluidically connected to a fluid source, a boost pump fluidically coupled to the fluid inlet, a cooling reservoir fluidically coupled to the control valve network, wherein the cooling reservoir comprises a bleed orifice, an actuation network fluidically coupled to the control valve network and the cooling reservoir, and a fluid outlet path fluidically coupled to the actuation network, includes operating the boost pump and opening the control valve network to provide fluid to the actuation network during an operational state, bleeding a portion of the fluid provided to the actuation network to fill the cooling reservoir with pressurized fluid during the operational state, ceasing operation of the boost pump and closing the control valve network during a non-operational state, thereby depressurizing the cooling reservoir, distributing cooling flow from the cooling reservoir to the actuation network during the non-operational state, and directing the cooling flow from the actuation network to the fluid outlet path.

The method of the preceding paragraph can optionally include, additionally and/or alternatively, any one or more of the following steps, features, configurations and/or additional components:

The fluid outlet path may be fluidically coupled to the fluid source.

The cooling reservoir may include a spring-loaded piston.

The fluid system may be housed within a gas turbine engine.

The operational state of the fluid circuit may occur when the gas turbine engine is operational.

The method may include bleeding excess fluid from the cooling reservoir through the bleed orifice when a spring-loaded piston within the cooling reservoir is pushed beyond the bleed orifice.

The method may include directing the excess fluid bled from the cooling reservoir through the bleed orifice to the fluid source.

The non-operational state of the fluid circuit may occur when the gas turbine engine is in an off state.

The method may include directing the cooling flow from the fluid outlet path back to the fluid source

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. A fluid system, comprising:
a fluid inlet fluidically connected to a fluid source;
a boost pump fluidically coupled to the fluid inlet;
a control valve network fluidically coupled to the boost pump;
a cooling reservoir fluidically coupled to the control valve network, wherein the cooling reservoir comprises a bleed orifice;
an actuation network fluidically coupled to the check valve network and the cooling reservoir; and
a fluid outlet path fluidically coupled to the actuation network.

2. The system of claim 1, wherein the cooling reservoir is a pressurizable reservoir.

3. The system of claim 1, wherein the fluid system is housed within a gas turbine engine.

4. The system of claim 3, wherein the cooling reservoir is configured to receive bleed flow from fluid flowing to the actuation network while the gas turbine engine is operational, thereby filling the cooling reservoir with fluid.

5. The system of claim 4, wherein the cooling reservoir is configured to be at a maximum capacity when a spring-loaded piston within the cooling reservoir is pushed beyond the bleed orifice.

6. The system of claim 5, wherein excess fluid entering the cooling reservoir when the cooling reservoir is at the maximum capacity is directed through the bleed orifice for return to the fluid source.

7. The system of claim 3, wherein the cooling reservoir is configured to distribute cooling flow to the actuation network when the gas turbine engine is in an off state.

8. The system of claim 7, wherein the cooling reservoir distributes cooling flow to the actuation network via operation of a spring-loaded piston within the cooling reservoir.

9. The system of claim 1, wherein the fluid outlet path is fluidically coupled to the fluid source.

10. The system of claim 1, further comprising a filter fluidically coupled to an outlet of the boost pump.

11. The system of claim 10, further comprising a fuel oil cooler fluidically coupled between the filter and the boost pump.

12. A method of operating a fluid circuit to provide cooling to an actuation network, the fluid circuit including a fluid inlet fluidically connected to a fluid source, a boost pump fluidically coupled to the fluid inlet, a cooling reservoir fluidically coupled to the control valve network, wherein the cooling reservoir comprises a bleed orifice, an actuation network fluidically coupled to the control valve network and the cooling reservoir, and a fluid outlet path fluidically coupled to the actuation network, the method comprising:
operating the boost pump and opening the control valve network to provide fluid to the actuation network during an operational state;
bleeding a portion of the fluid provided to the actuation network to fill the cooling reservoir with pressurized fluid during the operational state;
ceasing operation of the boost pump and closing the control valve network during a non-operational state, thereby depressurizing the cooling reservoir;
distributing cooling flow from the cooling reservoir to the actuation network during the non-operational state; and
directing the cooling flow from the actuation network to the fluid outlet path.

13. The method of claim 12, wherein the fluid outlet path is fluidically coupled to the fluid source.

14. The method of claim 12, wherein the cooling reservoir includes a spring-loaded piston.

15. The method of claim 12, wherein the fluid system is housed within a gas turbine engine.

16. The method of claim 15, wherein the operational state of the fluid circuit occurs when the gas turbine engine is operational.

17. The method of claim 16, further comprising:
bleeding excess fluid from the cooling reservoir through the bleed orifice when a spring-loaded piston within the cooling reservoir is pushed beyond the bleed orifice.

18. The method of claim 17, further comprising:
directing the excess fluid bled from the cooling reservoir through the bleed orifice to the fluid source.

19. The method of claim 15, wherein the non-operational state of the fluid circuit occurs when the gas turbine engine is in an off state.

20. The method of claim 12, further comprising:
directing the cooling flow from the fluid outlet path back to the fluid source.
